(19) United States
(12) Patent Application Publication
(10) Pub. No.: US 2003/0097424 A1
(43) Pub. Date: May 22, 2003

(54) Method to construct a technology roadmap

(76) Inventors: Jean-Christophe Pautrat, Sunnyvale, CA (US); Mobashar Yazdani, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 09/962,277

(22) Filed: Sep. 26, 2001

(51) Int. Cl. G06F 7/00

(52) U.S. Cl. 709/220

(57) ABSTRACT

A system includes a server and a client. The client includes a module to enter component information through a template into a data block and a module to send the data block in a predetermined format to the server. The template has a predetermined number of fields with each field being of a predetermined type of field. The server includes a module to check a consistency of the component data block and a module to store the consistency checked data block in a database. Alternatively a method includes entering component information through the template into a data block at a client, sending the data block in a predetermined format from the client to a server, checking a syntax of the data block at the server, and storing the syntax checked data block in a database.

### BACKGROUND OF THE INVENTION

1. Field of the Invention

The present invention relates to a method to construct a technology roadmap and software modules to mechanize the method. In particular, the invention relates to a method to use the interactive advantages of networks to reduce errors in such roadmaps and speed the roadmap construction process.

2. Description of Related Art

Today, vendors and suppliers send technology roadmaps to their customers either in paper or electronic data form in diverse formats: text, graphics, presentations, pdf files, etc. None of these forms are consistent. A technology roadmap is a set of blocks organized on a timeline in one dimension. Another dimension of the roadmap may be used to compare different vendors or suppliers. Each block on the timeline is delineated by a minimum date and a maximum date and is characterized by other parameters associated with the block (e.g., RAM as the component type, speed of 20 MHz and density of 64 M bits). Any particular roadmap depicts a timeline of component availabilities from several vendors of a particular product that meets specific parametric requirements. Different roadmaps are prepared for different products.

In the past, manufacturers developed gap analysis by manual operations, which took hours and allowed typos. In order to extract a roadmap on a specific parameter such as density, process technology, speed, organization, architecture, etc. across all those roadmaps, the final user either has to look at all of them one by one, or cut/paste a bmp version (bit mapped file) of them into a new bmp file, or manually create from scratch the desired gap analysis roadmap from the raw data. This could take hours, and was in fact unfeasible.

This method brings an instant and painless gap analysis from all suppliers accessible on latest supplier's data to any system integrator, procurement engineer, procurement specialist or R&D engineer in few clicks of a mouse.

### SUMMARY OF THE INVENTION

It is an object to the present invention to overcome limitations in the prior art. It is a further object of the present invention to automate preparation of technology roadmap gap analysis. It is yet another object to improve speed and reliability of and/or reduce the cost of gap analysis.

These and other objects are achieved in a system that includes a server and a client. The client includes a module to enter component information through a template into a component data block and a module to send the component data block in a predetermined format to the server. The template has a predetermined number of fields with each field being of a predetermined type of field. The server includes a module to check a consistency of the component data block and a module to store the consistency checked component data block in a component database.

These and other objects are alternatively achieved in another embodiment of the invention using a method that includes entering component information through a template into a component data block at a client, sending the component data block in a predetermined format from the client to a server, checking a syntax of the component data block at the server, and storing the syntax checked component data block in a component database. The template has a predetermined number of fields with each field being of a predetermined type of field.

These and other objects are alternatively achieved in yet another embodiment of the invention using a method that includes entering at least one sort parameter, culling a set of component data blocks from a component database according to the at least one sort parameter, preparing a roadmap from the set of component data blocks, and one of displaying and printing the roadmap.

### BRIEF DESCRIPTION OF DRAWINGS

The invention will be described in detail in the following description of preferred embodiments with reference to the following figures wherein:

FIG. 1 is a schematic diagram of the interconnections between client and server in a system according to the present invention;

FIG. 2 is a block diagram of a representative processing system according to the system of FIG. 1;

FIG. 3 is a software block diagram of the modules that make up the client according to the present invention;

FIG. 4 is a software block diagram of the modules that make up the server according to the present invention;

FIG. 5 is a representative roadmap according to the present invention;

FIG. 6 is a flow chart of an embodiment of the present invention; and

FIG. 7 is a flow chart of an alternative embodiment of the present invention.

### DETAILED DESCRIPTION OF PREFERRED EMBODIMENTS

In the present invention, component suppliers, such as dynamic RAM suppliers, describe their roadmaps with one file per block. A “block ” is the concept of graphical representation generally used by suppliers when they build their own graphs of product roadmaps.

Suppliers send this soft information to a manufacturer (email or floppy disc). Upon receiving, the file is checked for consistency and syntax and is merged into a database system. A specific program is able to sort the blocks according to certain parameters and criteria, and build a roadmap as per this parameter across all vendors. The program creates tens of different roadmaps, sorted by different criteria, in a matter of minutes. The resulting graphs are then available as pictures that can be used in the manufacturer's decisions (sent by emails to users, posted on web sites or other).

A manufacturer provides to suppliers client software with a template to use in order to provide a seamless data entry process. This client software also includes syntax verification.

Engaging with strategic memory suppliers and emerging suppliers, each supplier sends one or more roadmaps, and the company receives updates on a regular basis. This software approach standardizes the format of roadmaps sent. A server at a data receiving center generally hosts the data and tools to display mixed combinations.

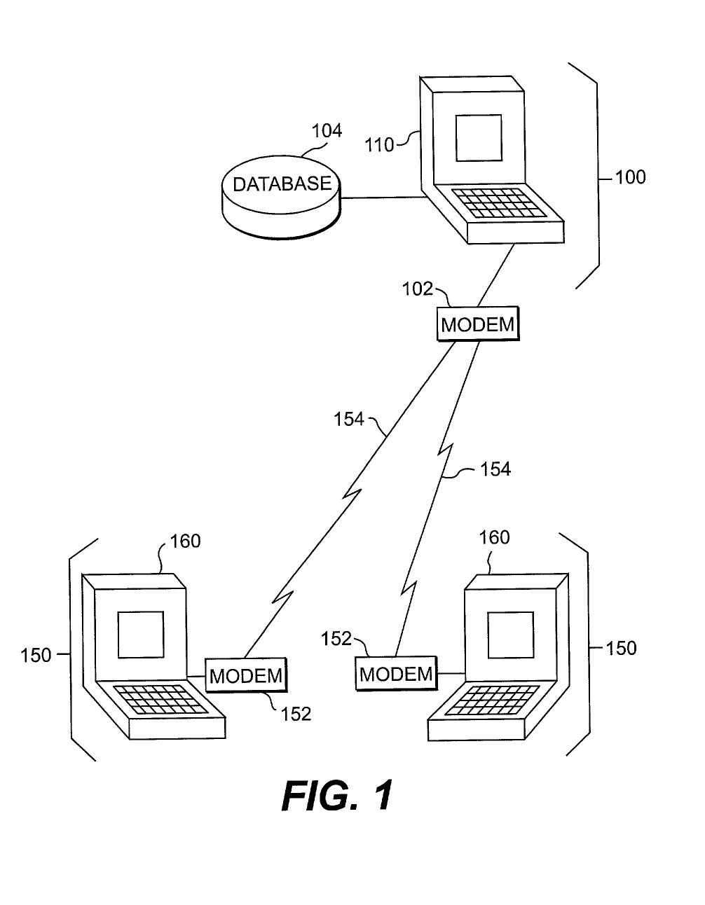

In FIG. 1, a system includes server 100 and at least one client 150. Server 100 includes modem 102, database 104 and processing system 110. Processing system 110 may be a microprocessor based computer hosting server software, a general purpose computer hosting the server software, or any of many equivalent server platforms. Each client 150 includes modem 152 and processing system 150. Processing system 150 may be a microprocessor based computer hosting client software, a general purpose computer hosting the client software, or any of many equivalent client platforms. Modem 102 is linked to each modem 152 over link 154. Link 154 is preferably a public access network such as a packet switched network (the most well known is called Internet) or directed connect network (the most well known is the plain old telephone system, known as POTS). Alternative networks are also contemplated as well as sending properly formatted computer readable media (e.g., floppy disks, or writable CD ROMS) between client and server (in which case modems 102 and 152 are to be regarded as suitable disk drives).

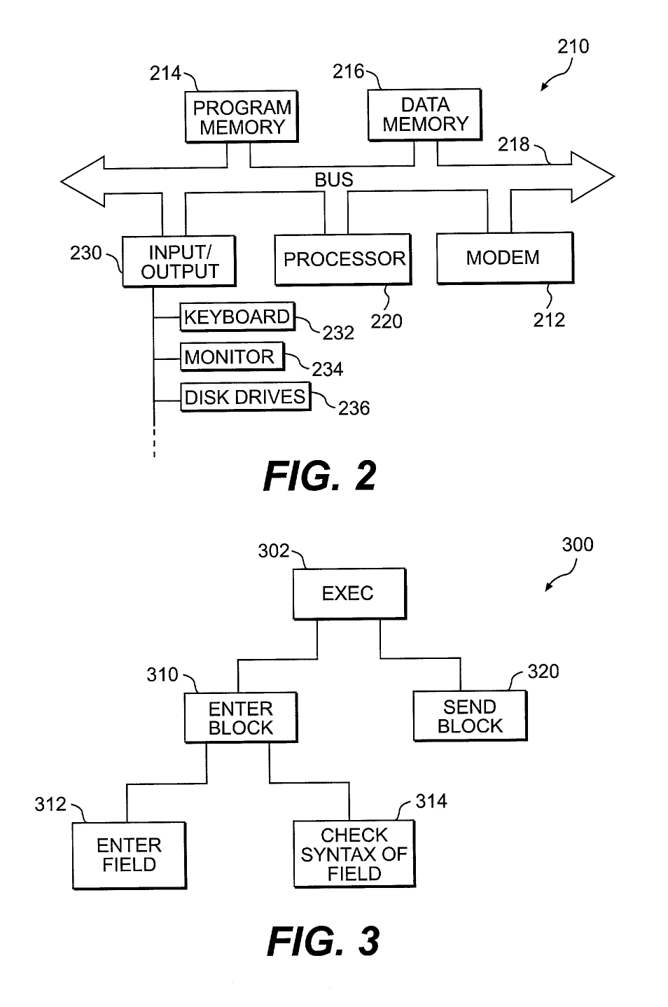

In FIG. 2, processing system 102 is representative of processing system 110 or 160. Processing system 102 includes modem 212 (corresponding to modem 102 or 152), program memory 214, data memory 216, common bus 218, processor 220 and miscellaneous input/output device 230 that has individual interfaces for keyboard 232, monitor 234 and disk drives 236. Program memory 214 stores the control program to implement the server or client software according to the present invention, and it may be any kind of memory from permanent memory (e.g., ROM or PROM) to traditional dynamic RAM where the program is loaded from a computer readable media such as a disk memory upon start up. Data memory 216 is typically RAM that stores constants, parameters, the template information according to the present invention, and a block of data that is being formed according to the present invention. Constants, parameters, the template information are typically loaded from a computer readable media such as a disk memory upon start up.

In FIG. 3, a representative structure of the client software is organized in program modules and sub-modules to perform specific tasks. Executive module 302 controls the passage of control to each of the other modules and sub-modules. The client software includes module 310 to control the processor to enter component information through a template into a component data block where the template has a predetermined number of fields with each field being of a predetermined type of field. The client software further includes module 320 to control the processor to send the component data block in a predetermined format to the server. Module 310 to enter component information includes sub-module 312 to repeatedly enter information elements until an information element has been entered for each field of the predetermined number of fields. Sub-module 312 includes all of the necessary loop control to index entry of each information element called for in the template. Module 310 to enter component information also includes sub-module 314 to check a syntax of the component information based on the predetermined type of field of the component information.

A representative template is shown in Table 1, where there are four fields (a predetermined number of fields) and there are two types of fields. A first type is the minimum and/or maximum number of units to ship per unit time, and a second type is a date.

TABLE 1

| | |
|---|---|
| Type of Field | Value of Field |

minimum shipping units per unit time
maximum shipping units per unit time
beginning date
ending date

In Table 1, the predetermine types of fields in the template include either a minimum shipping units per unit time field, a maximum shipping units per unit time field, a beginning date field, or an ending date field, and may include more than one of these fields.

The minimum shipping units per unit time field and the maximum shipping units per unit time field contemplate a value that is a number. The number of items in a unit of shipment might be expressed as each, as dozens, as a gross or other unit of shipment. Shipping per unit time might be the number of units available to ship per week, month or year. However, the client and server software must agree on the units of shipment and the units of time. Similarly, the client and server software must agree on the format in which the beginning and ending dates are encoded.

In this example there are four fields in the template. Sub-module 312 to repeatedly enter information elements until an information element has been entered for each field of the predetermined number of fields causes the data entry screen to be looped four times (once for each field). Sub-module 314 to check a syntax of the component information based on the predetermined type of field of the component information checks to ensure that information entered as a date is entered in a proper date format, and that information entered as a number is entered in a proper number format.

Another representative template is shown in Table 2, where there are two fields (a predetermined number of fields) and there is one type of field (a number)

TABLE 2

| | |
|---|---|
| Type of Field | Value of Field |

component speed
component density

The predetermine types of fields include either a component speed field or a component density field. A value of the component speed field includes a numerical speed when the predetermine type of field is a component speed field, and a value of the density field includes a number of storage bits in a memory when the predetermine type of field is a density field. Both fields take a value that is a number; however, here too it is important that the client and the server agree on the units of speed (e.g., MHz) and the component density (e.g., megabits where mega is defined to be either one million or 2 raised to the 20th power).

The predetermine types of fields may also include a graphical image field, and a value of the graphical image field might include a link to a graphical image object.

The predetermine types of fields may include a stage of development field, and a value of the stage of development field might be an indicia of the stage of development. For example, an indicia of an engineering sample might be 1, an indicia of a customer sample might be 2, an indicia of a mass production sample might be 3, and an indicia of an end of life sample might be 4.

The template of the present invention might include any of the above described fields in any combination, supplier identifying information (e.g., name of supplier, contact person, address, telephone number, payment arrangement, etc.) or in combination with fields not described herein. The client software directs entry of these fields through a template into a data block, and then sends the data block to the server.

In Table 3, a more comprehensive example of a block expressed in software (expressed in the XML language). Persons of ordinary skill in the art will appreciate that many alternative variants are achievable in light of these teachings.

TABLE 3
Technical [

Release Dates [

[ Engineering sample : date of engineering sample available ]
[ Customer sample : date of customer sample available ]
[ Manufacturing release : date of manufacturing release ]
[ End of life : end of life date ]

]

DRAM Technology [

[ Memory type : EDO, FPM, SDRAM, RDRAM, SLDRAM, DDRI, DDRII,

DDR1.5
]

[ Density (Mb) : total density in Mb ] [ Organization : x4, x8,

x16
x18, x32 etc. ]

[ Main Speed Spec : PC100, PC133, HP6A, PC600, PC700, PC800,

DDR200,
DDR266, DDR300 or any other in MHz ]

[ Second Speed Spec : potentialy HP6A or other ]
[ Latency : −333, −222 or CL2.5, CL2, CL1.5 or tRAC in ns ]
[ Die revision : enter letter or number ]
[ Package : TSOP, CSP, TQFP
[ Die size (mm²) enter value in mm² ]
[ Process technology (um) : enter value in um ]
[ Voltage (V) : enter value in V ]
[ shared die : yes or no ]
[ Site : enter production and assembly site ]
[ Comments field : Comments ]

]

]

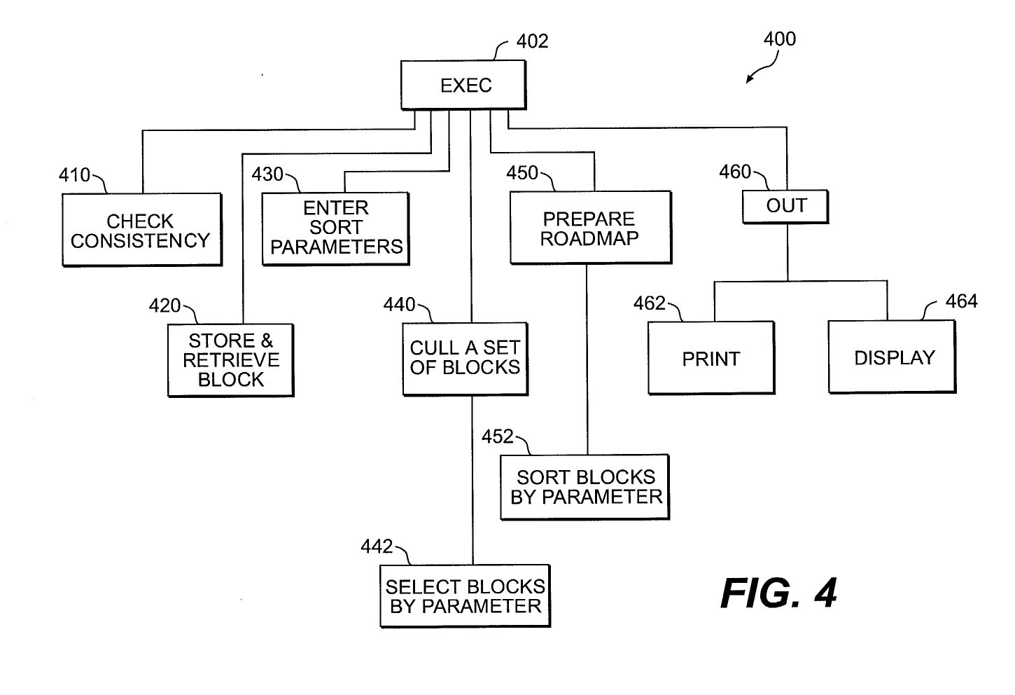

In FIG. 4, a representative structure of the server software is organized in program modules and sub-modules to perform specific tasks. Executive module 402 controls the passage of control to each of the modules and sub-modules. The server software includes module 410 to control the processor to check a consistency of the component data block (e.g., to ensure that it is in the proper format) and module 420 to control the processor to store the consistency checked component data block in component database 104. Server software further includes module 430 to enter at least one sort parameter (e.g., beginning date within in a month coupled with minimum shipment quantity of more than XXX), module 440 to cull a set of component data blocks from the component database according to the at least one sort parameter (e.g., that meet the sort criteria), module 450 to prepare a roadmap from the set of component data blocks, and module 460 to either display or print the roadmap.

In a variant of the above, module 430 to enter at least one sort parameter enters at least two sort parameters where each entered sort parameter is ordered by a precedence order. For example, the highest precedence might be shipment within a month with minimum shipment quantities greater than XXX, and the next highest precedence might be the maximum quantity that may be shipped per month.

Module 440 to cull includes sub-module 442 to cull all component data blocks having a first sort parameter where the first sort parameter has a highest precedence in the precedence order. In this example, module 440 would produce a list of blocks that meet a criteria of shipment within a month with minimum shipment quantities greater than XXX.

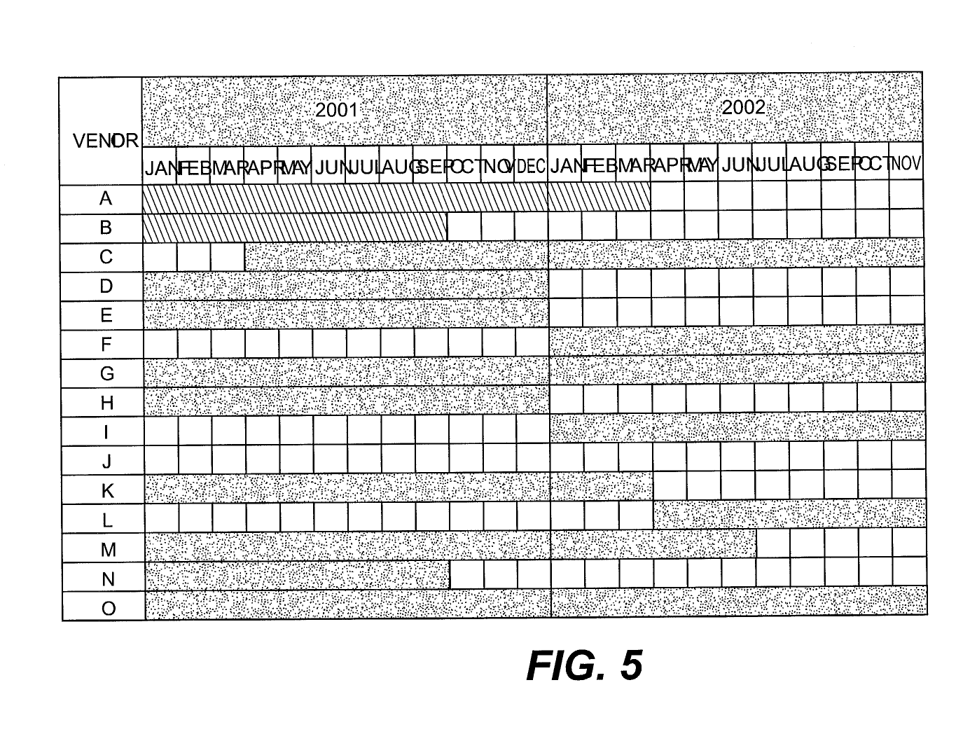

Module 450 to prepare includes sub-module 452 to sort all component data blocks according to a second sort parameter. In this example, module 450 would sort the list of blocks according to the maximum quantity that may be shipped per month specified in each block. Module 450 to prepare a roadmap would then format a roadmap. FIG. 5 illustrates a typical roadmap with 15 data blocks displayed. If the number of blocks in the culled list is greater than 15, module 450 would select the 15 blocks (e.g., corresponding to 15 vendors) with the largest number of maximum quantity that may be shipped per month specified in the blocks. FIG. 5 depicts a time line of nearly two years showing the monthly shipments of the component in question. With a little care taken to select the sort parameters, an operator of the server software can quickly construct a roadmap that provides a visual guidance of which vendors are able to supply projected needs of a particular manufactured product.

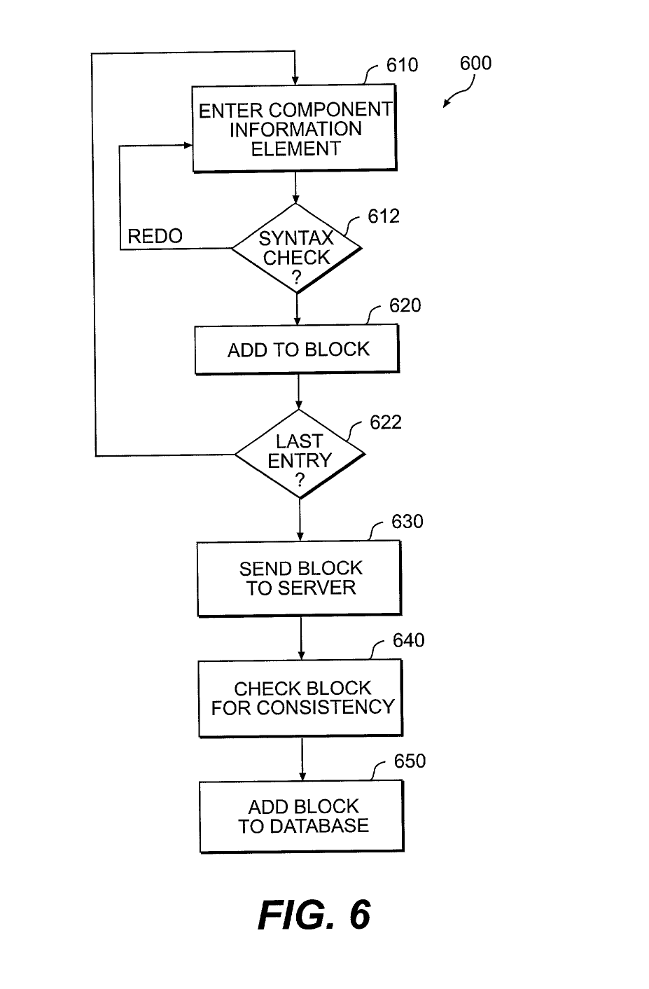

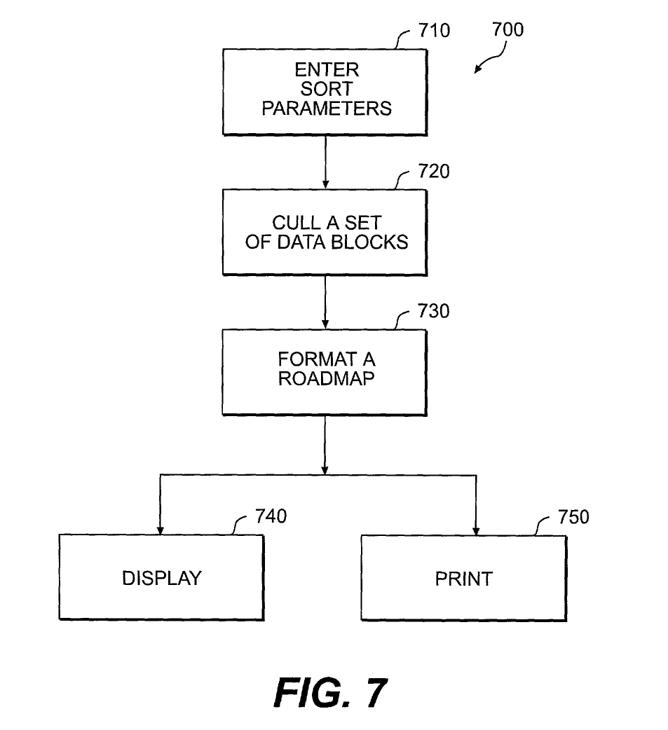

In FIG. 6, a method of preparing a roadmap includes entering component information through a template into a component data block at client 150 where the template has a predetermined number of fields with each field being of a predetermined type of field. In this method, entering component information includes entering a component information element 610, checking a syntax of the component information 612 based on the predetermined type of field of the component information, re-entering the element if the syntax check fails, and if not, adding the element to the data block 620, and repeating the step of entering information elements until an information element has been entered for each field of the predetermined number of fields 622.

The method includes sending the component data block 630 in a predetermined format from client 150 to server 100, checking a consistency of the component data block at the server 640, and storing the consistency checked component data block 650 in component database 104.

The method further includes entering at least one sort parameter 710, culling a set of component data blocks 720 from the component database according to at least one sort parameter, preparing a roadmap 730 from the set of component data blocks, and either displaying the roadmap 740 or printing the roadmap 750.

Preferably, the step of entering at least one sort parameter 710 includes entering at least two sort parameters where each entered sort parameter is ordered by a precedence order. In such case, the step of culling 720 includes culling all component data blocks having a first sort parameter where the first sort parameter has a highest precedence in the precedence order, and the step of preparing 730 includes sorting all component data blocks according to a second sort parameter.

Independent of how the client prepares data blocks and send the data block to the server for storage, a method includes entering at least one sort parameter 710, culling a set of component data blocks 720 from a component database according to the at least one sort parameter, preparing a roadmap 730 from the set of component data blocks, and either displaying the roadmap 740 or printing the roadmap 750.

Preferably, the step of entering at least one sort parameter 710 includes entering at least two sort parameters where each entered sort parameter is ordered by a precedence order. In such case, the step of culling 720 includes culling all component data blocks having a first sort parameter where the first sort parameter has a highest precedence in the precedence order, and the step of preparing 730 includes sorting all component data blocks according to a second sort parameter.

With this invention, the gap analysis of technology roadmaps can be done in minutes, and can be performed and is accessible from anywhere and at anytime over the internet.

Having described preferred embodiments of a novel method to construct a technology roadmap (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

What is claimed is:

1. A system comprising a server and a client, wherein:
the client includes a module to enter component information through a template into a component data block and a module to send the component data block in a predetermined format to the server, the template having a predetermined number of fields with each field being of a predetermined type of field; and
the server includes a module to check a consistency of the component data block and a module to store the consistency checked component data block in a component database.

2. The system of claim 1, wherein the module to enter component information includes a sub-module to repeatedly enter information elements until an information element has been entered for each field of the predetermined number of fields.

3. The system of claim 1, wherein the module to enter component information includes a sub-module to check a syntax of the component information based on the predetermined type of field of the component information.

4. The system of claim 1, wherein the server further includes:
a module to enter at least one sort parameter;
a module to cull a set of component data blocks from the component database according to the at least one sort parameter;
a module to prepare a roadmap from the set of component data blocks; and
a module to one of display and print the roadmap.

5. The system of claim 4, wherein the server further includes:
the module to enter at least one sort parameter enters a plurality of sort parameters, each entered sort parameter being ordered by a precedence order;
the module to cull includes a sub-module to cull all component data blocks having a first sort parameter, the first sort parameter having a highest precedence in the precedence order;
the module to prepare includes a sub-module to sort all component data blocks according to a second sort parameter.

6. The system of claim 1, wherein the predetermine type of field includes at least one of:
a minimum shipping units per unit time field;
a maximum shipping units per unit time field;
a beginning date field; and
an ending date field.

7. The system of claim 1, wherein:
the predetermine type of field includes at least one of a component speed field and a density field;
a value of the component speed field includes a numerical speed when the predetermine type of field is a component speed field; and
a value of the density field includes a number of bits when the predetermine type of field is a density field.

8. The system of claim 1, wherein:
the predetermine type of field includes a graphical image field; and
a value of the graphical image field includes a link to a graphical image object.

9. A method comprising steps of:
entering component information through a template into a component data block at a client, the template having a predetermined number of fields with each field being of a predetermined type of field;
sending the component data block in a predetermined format from the client to a server;
checking a syntax of the component data block at the server; and
storing the syntax checked component data block in a component database.

10. The method of claim 9, wherein the step of entering component information includes repeating a step of entering information elements until an information element has been entered for each field of the predetermined number of fields.

11. The method of claim 9, wherein the step of entering includes checking a syntax of the component information based on the predetermined type of field of the component information.

12. The method of claim 9, wherein the predetermine type of field includes at least one of:
a minimum shipping units per unit time field;
a maximum shipping units per unit time field;
a beginning date field; and
an ending date field.

13. The method of claim 9, wherein:
the predetermine type of field includes a stage of development field; and
a value of the stage of development field includes an indicia of one of an engineering sample, a customer sample, a mass production sample and an end of life sample.

14. The method of claim 9, wherein:
the predetermine type of field includes a component speed field; and
a value of the component speed field includes a numerical speed.

15. The method of claim 9, wherein:
the predetermine type of field includes a density field; and
a value of the density field includes a number of bits.

16. The method of claim 9, wherein:
the predetermine type of field includes a graphical image field; and
a value of the graphical image field includes a link to a graphical image object.

17. The method of claim 9, further comprising steps of:
entering at least one sort parameter;
culling a set of component data blocks from the component database according to the at least one sort parameter;
preparing a roadmap from the set of component data blocks; and
one of displaying and printing the roadmap.

18. The method of claim 17, wherein:
the step of entering at least one sort parameter includes entering a plurality of sort parameters, each entered sort parameter being ordered by a precedence order;
the step of culling includes culling all component data blocks having a first sort parameter, the first sort parameter having a highest precedence in the precedence order; and
the step of preparing includes sorting all component data blocks according to a second sort parameter.

19. A method comprising steps of:
entering at least one sort parameter;
culling a set of component data blocks from a component database according to the at least one sort parameter;
preparing a roadmap from the set of component data blocks; and
one of displaying and printing the roadmap.

20. The method of claim 19, wherein:
the step of entering at least one sort parameter includes entering a plurality of sort parameters, each entered sort parameter being ordered by a precedence order;
the step of culling includes culling all component data blocks having a first sort parameter, the first sort parameter having a highest precedence in the precedence order; and
the step of preparing includes sorting all component data blocks according to a second sort parameter.
